(19) United States
(12) Patent Application Publication
(10) Pub. No.: US 2025/0229626 A1
(43) Pub. Date: Jul. 17, 2025

(54) REDUCER FOR ELECTRIC VEHICLE AND ELECTRIC VEHICLE DRIVING SYSTEM INCLUDING THE SAME

(71) Applicants: HYUNDAI MOTOR COMPANY, SEOUL (KR); KIA CORPORATION, SEOUL (KR)

(72) Inventors: Jaejoon Lee, Hwaseong-si (KR); Ahram Lee, Hwaseong-si (KR); Joo Hang Lee, Hwaseong-si (KR); Jin Ho Kim, Hwaseong-si (KR)

(73) Assignees: HYUNDAI MOTOR COMPANY, SEOUL (KR); KIA CORPORATION, SEOUL (KR)

(21) Appl. No.: 18/971,709

(22) Filed: Dec. 6, 2024

(30) Foreign Application Priority Data
Jan. 11, 2024 (KR) 10-2024-0004833

(51) Int. Cl. B60K 17/04; B60K 7/00

(52) U.S. Cl. CPC B60K 17/043; B60K 7/0007; B60K 2007/0092

(57) ABSTRACT

A driving motor includes a motor output shaft and a reducer connecting a driving wheel. The reducer includes a first gear part including an inside internal gear internally meshed with a motor output gear mounted on the motor output shaft and an inside external gear coaxial with the inside internal gear, and a second gear part including an outside internal gear that is internally meshed with the inside external gear and a reducer output shaft that transmits power to the driving wheel.

### CROSS REFERENCE TO RELATED APPLICATIONS

This application claims priority to and the benefit of Korean Patent Application No. 10-2024-0004833 filed in the Korean Intellectual Property Office on Jan. 11, 2024, the entire contents of which are incorporated herein by reference.

### BACKGROUND

### (a) Field

The present disclosure relates to an electric vehicle driving system. More particularly, the present disclosure relates to a reducer for an electric vehicle and an electric vehicle driving system including the same.

### (b) Description of the Related Art

An electric vehicle is a vehicle that drives a motor by supplying electricity from a battery charged from an external power source or hydrogen battery, and transmits the torque of the motor to the driving wheels.

Since the rotation speed of the motor is high compared to the speed of the driving wheel, a reducer (or decelerator) with a gear ratio of approximately 10 must be applied between the motor and the driving wheel, and this reducer requires a compact structure for vehicle mounting (packaging) along with requirements for noise, performance, and cost.

The rated rotation speed of a motor applied to a vehicle is generally in the range of 10,000-20,000 rpm, and deceleration is required for application to a vehicle. Most electric vehicles currently in mass production mainly use reducers that combine external gears and reducers that use planetary gears.

There are many performance factors such as cost, weight, and efficiency, but packageability is a key factor in determining whether a motor/reducer system can be mounted on a vehicle.

In the case of a structure in which external gears are arranged in parallel, the total length may be relatively reduced by eccentrically arranging the motor and output shafts, but the total width tends to be relatively large, so interference with adjacent parts may become a problem when installed.

The method of arranging the planetary gear coaxially (or inline) with the motor can relatively reduce the overall width, but has the problem of the overall length becoming relatively longer and causing drive shaft direction interference and packaging problems.

The matters described in this background art section are written to improve understanding of the background of the disclosure, and may include matters that are not conventional art already known to a person of an ordinary skill in the field to which this technology belongs.

### SUMMARY

The present disclosure attempts to provide a reducer for an electric vehicle that can reduce the entire size and improve the loadability, and an electric vehicle driving system including the same.

A reducer according to an embodiment may connect a driving motor including an output shaft and a driving wheel.

The reducer according to an embodiment may include a first gear part including an inside internal gear internally meshed with a motor output gear mounted on the motor output shaft and an inside external gear coaxial with the inside internal gear, and a second gear part including an outside internal gear that is internally meshed with the inside external gear and a reducer output shaft that transmits power to the driving wheel.

According to an embodiment of an electric vehicle driving system, the driving motors may be provided in pairs so that the output shaft is arranged on the outside, and the reducer may be provided in pairs to transmit the output of each driving motor to the driving wheels provided in pairs

An electric vehicle driving system according to an embodiment may include a driving motor including a motor output gear, a driving wheel, and a reducer including an inside internal gear that is internally meshed with the motor output gear and reduces the rotation speed of the driving motor to transmit it to the driving wheel.

The reducer may include an inside external gear coaxial with the inside internal gear, and an outside internal gear that is internally meshed with the inside external gear.

The driving motors may be provided in pairs and are arranged symmetrically to each other, so that the motor output shaft of each driving motor is arranged on the outer side.

The driving wheel may include a left driving wheel and a right driving wheel, and the reducers may be arranged in pairs to transmit each torque of the driving motor to the left driving wheel and the right driving wheel, respectively.

Each driving motor may be driven independently.

According to an embodiment of the reducer for an electric vehicle and the electric vehicle driving system including the same, the entire size can be reduced, thereby improving loadability.

In addition, according to an embodiment of the reducer for an electric vehicle and the electric vehicle driving system including the same, NVH can be reduced by increasing the gear meshing amount by using an internal gear that is internally meshed, compared to a reducer having a similar size and similar gear ratio.

In addition, the effects that can be obtained or expected from embodiments of the present disclosure are directly or implicitly disclosed in the detailed description of the embodiments of the present disclosure. That is, various effects predicted according to embodiments of the present disclosure will be disclosed in the detailed description to be provided later.

### BRIEF DESCRIPTION OF THE FIGURES

Since these drawings are for reference in explaining exemplary embodiments of the present disclosure, the technical ideas of the present disclosure should not be interpreted as limited to the attached drawings.

FIG. 1 is a side cross-sectional view showing a reducer for an electric vehicle according to an embodiment.

FIG. 2 is a front view showing the configuration of a reducer for an electric vehicle according to an embodiment.

FIG. 3A and FIG. 3B are drawings comparing a general reducer and a reducer for an electric vehicle according to an embodiment.

FIG. 4A and FIG. 4B are drawings comparing sizes of a general reducer and a reducer for an electric vehicle according to an embodiment.

FIG. 5 is a side cross-sectional view showing an electric vehicle driving system according to an embodiment.

It should be understood that the drawings referenced above are not necessarily drawn to scale, but rather present rather simplified representations of various preferred features illustrating the basic principles of the present disclosure.

For example, specific design features of the present disclosure, including specific dimensions, orientations, locations, and shapes, will be determined in part by the particular intended application and usage environment.

### DETAILED DESCRIPTION

Hereinafter, with reference to the attached drawings, embodiments of the present disclosure will be described in detail so that a person having ordinary skill in the art to which the present disclosure pertains can easily implement the present disclosure.

As those skilled in the art would realize, the described embodiments may be modified in various different ways, all without departing from the spirit or scope of the present disclosure.

In order to clearly explain the present disclosure, parts irrelevant to the description are omitted, and the same reference numerals are used for identical or similar components throughout the specification.

The size and thickness of each component shown in the drawings are arbitrarily shown for convenience of explanation, and therefore the present disclosure is not necessarily limited to what is shown in the drawings, and the thickness is shown in an enlarged form to clearly express various parts and areas.

In addition, in the detailed description below, the names of the components are divided into first, second, etc. to distinguish them when the components are in a similar relationship, and the description below is not necessarily limited to that order.

Throughout the specification, whenever a part is said to include a certain component, this does not mean that it excludes other components, but rather that it may include other components, unless otherwise specifically stated.

Additionally, terms such as . . . part, . . . means, etc. described in the specification mean comprehensive units of composition that perform at least one function or operation.

When we say that a part, such as a layer, membrane, region, or plate, is “over” another part, this includes not only cases where it is directly over the other part, but also cases where there are other parts in between.

In contrast, when an element is referred to as being “directly on” another element, there are no intervening elements present.

The terms ‘vehicle’, ‘of a vehicle’ or other similar terms used in this specification are generally used in passenger automobiles, including passenger vehicles, sport utility vehicles (SUVs), buses, trucks, and various commercial vehicles, and also including hybrid vehicles, electric vehicles, hybrid electric vehicles, hydrogen power vehicles and other alternative fuel vehicles (e.g., fuels derived from resources other than petroleum).

An embodiment will hereinafter be described in detail with reference to the accompanying drawings.

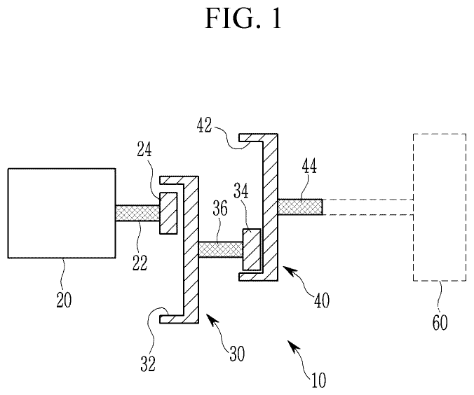

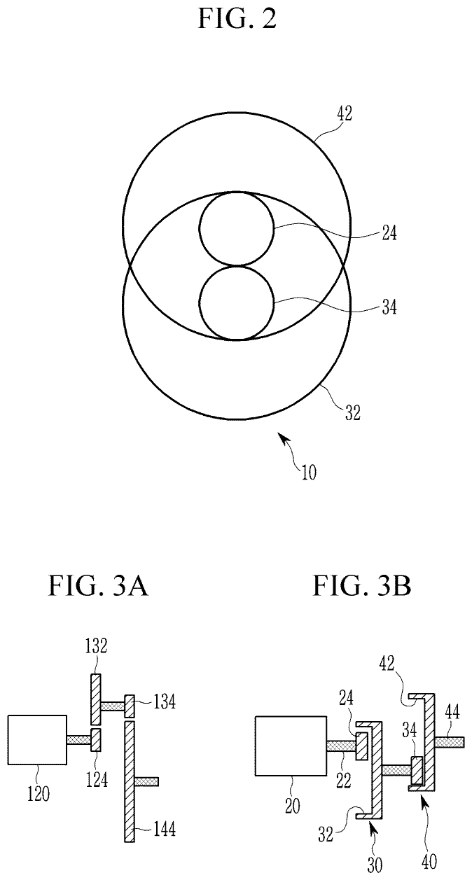

FIG. 1 is a side cross-sectional view showing a reducer for an electric vehicle according to an embodiment, and FIG. 2 is a front view showing the configuration of a reducer for an electric vehicle according to an embodiment.

Referring to FIG. 1 and FIG. 2, an electric vehicle driving system according to an embodiment may include a driving motor 20, a driving wheel 60, and a reducer 10 according to an embodiment that reduces a rotation speed of the driving motor 20 and transmits a torque of the driving motor 20 to the driving wheel 60.

The driving motor 20 includes a motor output gear 24 that outputs a driving torque of the driving motor 20, and the reducer 10 includes an inside internal gear 32 that is internally meshed with the motor output gear 24, and the reducer 10 may reduce the rotation speed of the driving motor 20 and transmit it to the driving wheel 60.

The reducer 10 may include an inside external gear 34 coaxial with the inside internal gear 32, and an outside internal gear 42 internally meshed with the inside external gear 34.

The motor output gear 24 may be an external gear mounted on a motor output shaft 22 of the driving motor 20.

That is, the reducer 10 includes a first gear part 30 and a second gear part 40, and the first gear part 30 includes the inside internal gear 32 which is internally meshed with the motor output gear 24 and the inside external gear 34 which is connected to the inside internal gear 32 by a gear shaft 36.

The second gear part 40 may include an outside internal gear 42 that is internally meshed with the inside external gear 34 and a reducer output shaft 44 that transmits power to the driving wheel 60.

Although the drawing shows the reducer output shaft 44 as being directly connected to the one driving wheel 60, it is not limited thereto, and a configuration such as a differential gear, a connecting gear, or a drive chain, which is not shown, may be intervened to transmit the torque of the reducer output shaft 44 to the driving wheel 60.

The configuration of the differential gear, the connecting gear, or the drive chain, etc., is obvious to those skilled in the art, so a detailed description is omitted.

The reducer output shaft 44 may be placed adjacent to the motor output shaft 22, depending on the gear ratio of each gear pair.

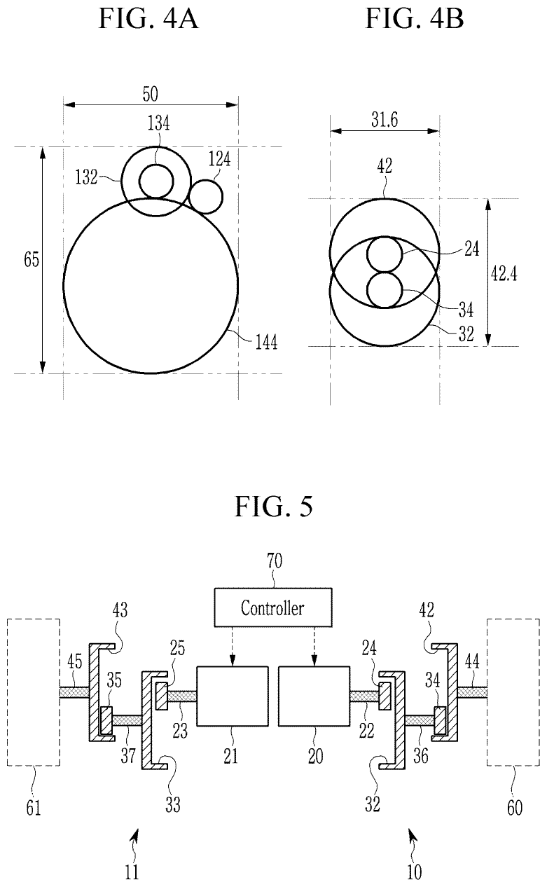

FIG. 3A and FIG. 3B are drawings comparing a general reducer and a reducer for an electric vehicle according to an embodiment, and FIG. 4A and FIG. 4B are drawings comparing sizes of a general reducer and a reducer for an electric vehicle according to an embodiment.

FIG. 3A and FIG. 4A are drawings showing a reducer configuration using two sets of external gears widely used in mass-produced vehicles, and FIG. 3B and FIG. 4B are drawings showing a reducer configuration for an electric vehicle according to an embodiment.

Referring to FIG. 3A to FIG. 4B, a size comparison of a typical reducer for an electric vehicle using an external gear and the reducer for an electric vehicle according to an embodiment of a assuming a gear ratio of 10, is shown.

For example, in a typical electric vehicle reducer, if the gear teeth of the output gear 124 of the driving motor 120, a first gear 132 externally meshed with the output gear 124, the second gear 134 coaxial with the first gear 132, and a third gear 144 externally meshed with the second gear 134 are 10, 20, 10, and 50, respectively, the total gear ratio becomes 10 {e.g. (20*50)/(10*10)}.

In an embodiment of a reducer for an electric vehicle, if the gear ratios of the motor output gear 24, the inside internal gear 32, the inside external gear 34, and the outside internal gear 42 are 10, 31.6, 10, and 31.6, respectively, the total gear ratio becomes approximately 10 {(31.6*31.6)/(10*10)}.

In the case of configuring the same total gear ratio of 10, compared to a general electric vehicle reducer using external gears, in the case of an embodiment of a reducer for an electric vehicle using internal gears, the vertical direction width is reduced by about 35% from 65 to 42.4, and the horizontal direction width is reduced by 37% from 50 to 31.6. For ease of understanding, the units of length are omitted for explanation.

That is, in the case of the reducer for an electric vehicle according to an embodiment using internal gear, it can be seen that the relative size is reduced and the loadability is dramatically improved.

Additionally, assuming that the full-length direction dimensions are designed at a similar level, the entire weight can also be reduced.

FIG. 5 is a side cross-sectional view showing an electric vehicle driving system according to an embodiment.

Referring to FIG. 5, an electric vehicle driving system according to an embodiment may include a left driving wheel 61 and a right driving wheel 60 and left and right driving motors 21 and 20 for driving the left driving wheel 61 and the right driving wheel 60, respectively.

The driving motors 21 and 20 may be provided as a pair and may be arranged symmetrically to each other so that motor output shafts 23 and 22 of each of the driving motors 21 and 20 may be arranged on the outer side.

Additionally, the reducers 10, and 11 may be arranged in pairs to transmit the respective torques of the driving motors 21 and 20 to the left driving wheel 61 and the right driving wheel 60, respectively.

That is, the left driving motor 21 is arranged symmetrically with the right driving motor 20 to drive the left driving wheel 61.

The reducer 10 on the left has a configuration symmetrical to the reducer 10 illustrated in FIG. 1, and each component is identical.

That is, the reducer 11 on the left may include a motor output gear 25 coupled to the motor output shaft 23, an inside internal gear 33 internally meshed with the motor output gear 25, an inside external gear 35 coaxially connected with the inside internal gear 33, i.e., connected by a gear shaft 37, an outside internal gear 43 internally meshed with the inside external gear 35, and a reducer output shaft 45 that transmits power to the driving wheel 61.

The driving motors 21 and 20 may be driven independently.

That is, a controller 70 may independently control the operation of each driving motor 21 and 20 according to the driving situation of the vehicle, enabling stable operation of the vehicle.

According to an electric vehicle driving system according to an embodiment, the width direction and height direction size of the entire system can be reduced by configuring the left and right driving motors 21 and 20 and the left and right reducers 10, thereby improving the mountability.

In addition, according to an embodiment of the reducer for an electric vehicle and an electric vehicle driving system including the same, NVH can be reduced by increasing the gear meshing amount by using an internal gear that is internally meshed, compared to a reducer having a similar size and similar gear ratio.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

1. A reducer for an electric vehicle, connecting a driving motor including a motor output shaft and a driving wheel, the reducer comprising:
a first gear part including an inside internal gear internally meshed with a motor output gear mounted on the motor output shaft, and an inside external gear coaxial with the inside internal gear; and
a second gear part including an outside internal gear that is internally meshed with the inside external gear and a reducer output shaft that transmits power to the driving wheel.

2. An electric vehicle driving system, wherein the driving motor comprises a first driving motor and a second driving motor, wherein the output shaft is arranged on an outside of the first driving motor and an outside of the second driving motor, and
wherein the reducer of claim 1 comprises a first reducer configured to transmit output of the first driving motor to a first driving wheel and a second reducer configured to transmit output of the second driving motor to a second driving wheel.

3. An electric vehicle driving system comprising:
a driving motor including a motor output gear;
a driving wheel; and
a reducer including an inside internal gear that is internally meshed with the motor output gear, and is configured to reduce a rotation speed of the driving motor to transmit the rotation speed to the driving wheel.

4. The electric vehicle driving system of claim 3, wherein the reducer comprises:
an inside external gear coaxial with the inside internal gear; and
an outside internal gear that is internally meshed with the inside external gear.

5. The electric vehicle driving system of claim 4, wherein the driving motor comprises a first driving motor and a second driving motor arranged symmetrically to each other, so that the motor output shaft of each driving motor is arranged on an outer side.

6. The electric vehicle driving system of claim 5, wherein:
the driving wheel comprises a left driving wheel and a right driving wheel; and
the reducer comprises a first reducer configured to transmit torque of the first driving motor to the left driving wheel and a second reducer configured to transmit torque of the second driving motor to the right driving wheel.

7. The electric vehicle driving system of claim 6, wherein each driving motor is driven independently.
